(19) United States
(12) Patent Application Publication
(10) Pub. No.: US 2008/0004072 A1
(43) Pub. Date: Jan. 3, 2008

(54) User Equipment With Wired Discontinuous Mobile Communication Function and the Method Thereof

(76) Inventor: Jun Yu, Shenzhen (CN)

Correspondence Address: MATTHIAS SCHOLL, 14781 MEMORIAL DRIVE, SUITE 1319, HOUSTON, TX, 77079, US

(21) Appl. No.: 11/572,829

(22) PCT Filed: Jul. 28, 2005
(86) PCT No.: PCT/CN05/01145

§ 371 Date: Jan. 29, 2007

(30) Foreign Application Priority Data
Jul. 30, 2004 (CN) 200410050888.6

(51) Int. Cl. H04M 1/00

(52) U.S. Cl. 455/554.2; 379/142.15

(57) ABSTRACT

Provided herein is a user equipment with a wired discontinuous mobile communication function and the method thereof applicable to the wired communication user equipment technology field. There are two implementation of the invention. The first is a wired single-mode user equipment including a wired mobile equipment, a universal integrated circuit card, and a terminal equipment. The other is a converging wireless/wired multi-mode and multi-network user equipment including a wireless/wired mobile equipment, a universal integrated circuit card, and a terminal equipment. Compared with a conventional wired communication user equipment, the user equipment and the method of this invention preserves the advantages of wired communication while implementing the wired discontinuous mobile communication function, thereby overcoming the deficiencies of conventional wired communication user equipments, such as fixing, stillness, and so on. Moreover, the converging wireless/wired multi-mode and multi-network user equipment of this invention provides wireless mobile communication with the possibility of sharing the numerous advantages of wired communication in a wired communication environment.

### FIELD OF THE INVENTION

The invention relates to the communication technology field, specifically to the wired communication user terminal equipment technology field, and particularly to a user equipment with a wired discontinuous mobile communication function and the method thereof.

### DESCRIPTION OF THE RELATED ART

Based on their communication modes, user communication terminal equipments are divided into wireless communication user equipment and wired communication user equipment.

Present wired communication network technologies like PSTN/ISDN have several advantages, such as friendly communication environments, abundant wired bandwidth resources, high communication quality, more simpler communication and control technology than wireless mobile technologies, security, and reliability. However, compared with wireless mobile communication technologies, the deficiencies of a wired communication network and the wired user terminal equipment, such as fixing, stillness, non-removability, dedication, and non-sharing, severely affect and restrict further and fast development thereof, and make it difficult to adequately utilize the advantages of wired communication technologies in terms of the wired bandwidth resources and so on. Although an emerging IP telephone user terminal equipment based on H.323 and SIP has many advantages as an IP packet technology, its communication relies on an IP address/ domain name which needs to be translated into an IP address. The IP address associatively corresponding to a packet access network device and an access position. As an user equipment changes its access port and position, the packet core network and packet access network device are required to reallocate and configure a new IP address to the user equipment for this change, it is difficult to implement bidirectional communication with numerous traditional PSTN/ISDN and PLMN user equipments. A telephone service for communicating via a unique number is also lacking, as is a telecommunication management and control mechanism, unlike a PSTN or PLMN telecommunication network. Especially problematic is the fact that IP internet network technology based on a non-real time service bearer and a connectionless-oriented service, along with the hybrid transmission and switching of a real time service and a non-real time service, lack the QoS and security assurance of a telecommunication network. Wireless communication, especially wireless mobile communication and the user terminal equipment thereof, have brought agility and convenience to customers in recent years due to the characteristics of such wireless and mobility. The user equipment for wireless mobile communication has advanced from earlier single-function and single-mode user terminal equipments like TACS, AMPS, DAMPS, GSM, IS-95A, and so on, to today's multi-function and multi-mode user equipments, such as GSM/GPRS, IS95A/B, cdma2000 1x, GSM/cdma2000 1x, and so on. It will continue to advance to future wireless multi-mode, multi-network, multimedia, and multi-function user equipment like 3G WCDMA, cdma2000, TD-SCDMA, Wi-Fi, WiMax, and so on. However, there are inherent, inevitable and unsolvable drawbacks and problems with wireless communication technologies, such as the insufficiency and costliness of wireless frequency resources, low security and privacy, bad communication environments, comparatively poor communication quality, and the requirements for high power radio frequency technologies, along with the increasing complexity of wireless mobile communication and control technologies. These drawbacks and problems with wireless communication technology represent the advantages of wired communication.

### SUMMARY OF THE INVENTION

As described above, there is a need for a new network and user terminal equipment technology, namely a discontinuous mobile wired communication technology, which can implement mobile communication in a wired environment to adequately make use of the many advantages of wired communication. On the other hand, wired/wireless communication technologies, networks, and user equipments are converging to enable wireless mobile communication to be flexible and convenient, and to share the advantages of wired communication in some circumstances. It is one object of the invention to provide user equipment with a wired discontinuous mobile communication function.

Another object of the invention is to provide a method applicable to user equipment with a wired discontinuous mobile communication function, to solve the problems and deficiencies of present wired communication user equipment, such as fixing, stillness, and dedication, and to adequately utilize the many advantages of wired communication.

The invention provides a novel user equipment with a wired discontinuous mobile communication function. To attain the above objectives, the user equipment of the invention comprises a wired mobile equipment, a universal integrated circuit card, and a terminal equipment. The wired mobile equipment comprises a wired mobile termination and a termination adaptor, and the wired mobile termination comprises a network termination and a wired termination. The universal integrated circuit card comprises a universal subscriber identify module. Based on the architecture defined by ITU-T1.410, the network termination is connected to the wired termination using a T reference point interface, and the wired mobile termination in the wired mobile equipment is connected to the termination adaptor and the universal subscriber identify module in the universal integrated circuit card via the network termination. The wired mobile equipment is connected to the terminal equipment via the termination adaptor by referring to an R reference. The wired user equipment is connected to external user applications, such as computers, via the terminal equipment, and to a wired access network of a wired discontinuous mobile communication network via the wired termination of the wired mobile termination in the wired mobile equipment.

The user equipment with the wired discontinuous mobile communication function of the invention is a network functional element of the wired discontinuous mobile communication network and a network access device used by a subscriber, which provides communication service application interfaces and services to the subscriber, and has a unique and fixed international mobile equipment identity. The functions of the user equipment comprise: service provision, network login and logoff, access address and location updating, providing a standard interface for plugging in the universal integrated circuit card and the universal subscriber identify module, basic subscriber identification and variable utilization for different subscribers, providing a user interface, supporting an emergency call without subscriber identification, capability of an application programming interface, downloading and storing information, services, functions and protocols, and maintaining a virtual home environment as roaming occurs. The wired mobile equipment in the user equipment is responsible for terminating the functions of all the control planes and wired discontinuous mobile communication network bearer services of a user layer, and the wired mobile termination therein is responsible for terminating communication network system services. The termination adaptor is responsible for adaptation between the wired mobile equipment and the terminal equipment through referring to the R reference point. The terminal equipment in the wired user equipment is a functional device providing subscriber terminal applications. The universal subscriber identify module in the universal integrated circuit card stores subscriber network attributes and subscriber and service information data for the user equipment of the invention, and is responsible for terminating the independent control functions of the user in a local network.

To attain the above objectives, a user equipment with the wired discontinuous mobile communication function of the invention may change its access address and position in a wired discontinuous mobile communication network, and switch to the coverage area of another wired access network in the wired discontinuous mobile communication network for various communication services and applications via the same wired access technology, without varying its fixed and unique number thereof. Therefore, each functional element in the user equipment of the invention corresponds to, as well as cooperates and interoperates with, that in the wired discontinuous mobile communication network, the wired mobile equipment corresponding to a mobile communication network system, the wired termination therein corresponding to a wired access network, the network termination corresponding to a switching component, a routing component, and a control component in a wired core network, the universal subscriber identify module in the universal integrated circuit card corresponding to a user and user equipment information database in the wired core network, and the terminal equipment corresponding to a terminal equipment in an external communication network. There are two implementations of the user equipment of the invention, one is a wired single-mode user equipment with a wired discontinuous mobile communication function only, and the other is a wireless/wired multi-mode and multi-network user equipment converging a wireless mobile communication function and a wired discontinuous mobile communication function, with the wireless mobile communication function including one or more wireless mobile communication technologies, such as 2G GSM/GPRS, IS95A/B, IMT-2000 WCDMA, CDMA2000, TD-SCDMA, and so on. Logically, the multi-mode and multi-network user equipment of the invention is divided into two independent functional entities: a wired discontinuous mobile communication user equipment and a wireless mobile communication user equipment. The multi-mode and multi-network user equipment of the invention determines the enabling/disabling of the logic function entities according to a single-network attribute or a multi-network attribute of the universal subscriber identify module in the universal integrated circuit card, along with the actual access type of the user equipment.

Compared with present wired communication user equipment, the user equipment and method thereof preserves the advantages of wired communication while implementing a wired discontinuous mobile communication function, thereby overcoming the deficiencies of the present wired communication user equipment, such as fixing, stillness, and so on. Moreover, a converging wireless/wired multi-mode and multi-network user equipment of the invention provides wireless mobile communication with the possibility of sharing the numerous advantages of wired communication in a wired communication environment.

### BRIEF DESCRIPTION OF THE DRAWINGS

FIG. 1 is a principle structural diagram of the wired single-mode user equipment with a wired discontinuous mobile communication function of the invention;

FIG. 2 is a principle structural diagram of a wireless/wired multi-mode and multi-network user equipment converging a wireless mobile communication function and a wired discontinuous mobile communication function; and

FIG. 3 is an embodiment of a wireless/wired multi-mode and multi-network user equipment in a communication network where a wireless mobile network and wired discontinuous mobile network converge.

### DETAILED DESCRIPTION OF THE INVENTION

A detailed description of an user equipment and the method thereof according to the invention will be given below in conjunction with the accompanying drawings.

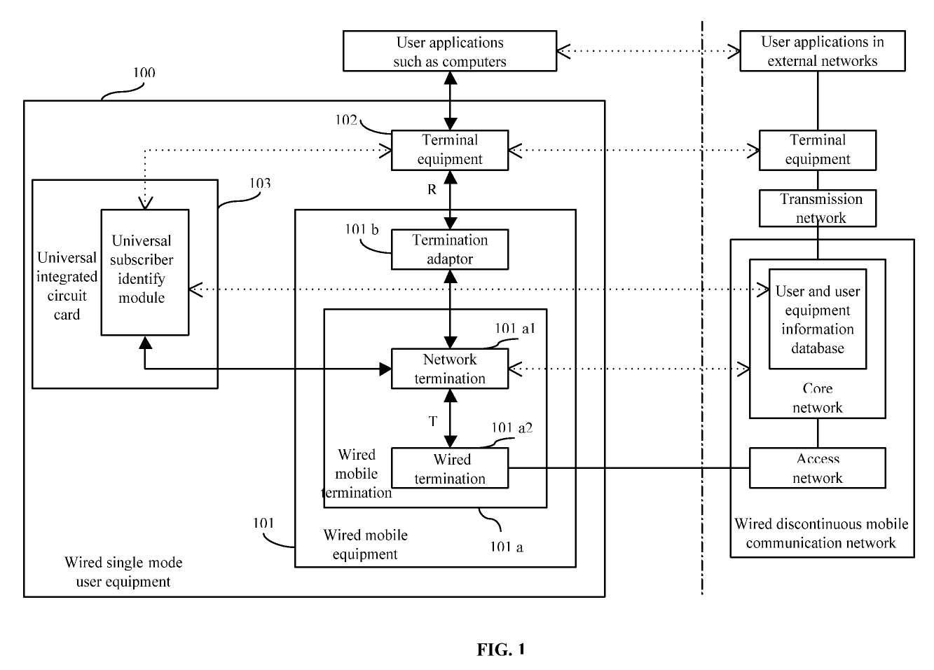

FIG. 1 is a structural implementation of the user equipment with the wired discontinuous mobile communication function of the invention, namely it is the principle structural diagram of a wired single-mode user equipment. The wired single-mode user equipment 100 comprises a wired mobile equipment 101, a terminal equipment 102 and a universal integrated circuit card 103. The wired mobile equipment 101 comprises a wired mobile termination 101a and a termination adaptor 101b, and the wired mobile termination 101a comprises a network termination 101a1 and a wired termination 101a2. The universal integrated circuit card 103 comprises a universal subscriber identify module arranged therein. The network termination 101a1 is connected to the wired termination 101a2, through a T reference point interface, and the wired mobile termination 101a in the wired mobile equipment 101 is connected to the termination adaptor 101b and the universal subscriber identify module in the universal integrated circuit card 103 via the network termination 101a1. The wired mobile equipment 101 is connected to the terminal equipment 102 through an R reference point. The wired single-mode user equipment 100 is connected to external user applications, such as computers, via the terminal equipment 102, and to a wired access network of a wired discontinuous mobile communication network via the wired termination 101a2 of the wired mobile termination 101a in the wired mobile equipment 101.

The wired mobile equipment 101 in the wired single-mode user equipment 100 is responsible for terminating the wired discontinuous mobile communication network bearer services of a user layer and the functions of all control planes. The wired mobile termination 101a is an originating and terminating end of the wired transmission over the wired discontinuous mobile communication network. It meets the various requirements for wired transmission, is able to change the access address and position thereof in a wired access network, transfer and switch to the coverage area of another wired access network via the same wired access technology, and is a service terminal of the wired communication network system that is responsible for terminating communication network system service. The network termination 101a1 is responsible for wired discontinuous mobility management and communication management, such as circuit service call control and packet service session management, according to a non-access layer protocol, and is responsible for terminating wired discontinuous mobile core network service. The wired termination 101a2 cooperates with the wired access network for wired-access to the discontinuous mobile wired communication network via an access layer protocol. It is responsible for terminating all services employing the wired access technology, and terminates the access layer. The termination adaptor 101b is responsible for adaptation and connection between the wired mobile equipment 101 and the terminal equipment 102 through the R reference point. The terminal equipment 102 in the wired single-mode user equipment 100 is a functional device providing subscriber terminal applications. It interoperates with the wired mobile termination 101a via the R reference point and the termination adaptor 101b in the wired mobile equipment 101, allowing the subscriber to receive normalized communication services and to terminate communication services transmitted via the wired discontinuous mobile communication network bearer service. It also provides the subscriber with various applications, such as access to computer equipment, with application interface service support. The universal subscriber identify module in the universal integrated circuit card 103 terminates user-independent control functions in the local network, and stores subscriber network attributes, along with subscriber and service information data required for security management, access control, wired discontinuous mobility management, call control, and communication management as the user equipment accesses the wired discontinuous mobile communication network. The service information data comprises management data, such as fixed data including fixed and unique telephone numbers, identification numbers, key data for security algorithms, subscriber network attributes, network access permission information, and so on; temporary network data, such as address information for a current position, wired discontinuous mobility management information, encrypted data, and so on; service-related information, comprising internal data relating to the availability and permission status of various services; some small applications, such as JAVA; and personal subscriber data.

As shown in FIG. 1, the components and functions thereof for the wired single-mode user equipment 100 correspond to those in the wired discontinuous mobile communication network, the wired mobile equipment 101 corresponding to a complete wired discontinuous mobile communication network system, the network termination 101a1 corresponding to a switching component, a routing component, and a control component in a wired core network, the wired termination 101a2 corresponding to the wired access network, the terminal equipment 102 corresponding to a terminal equipment in an external communication network, and the universal subscriber identify module in the universal integrated circuit card 103 corresponding to a user and user equipment information database in the wired core network.

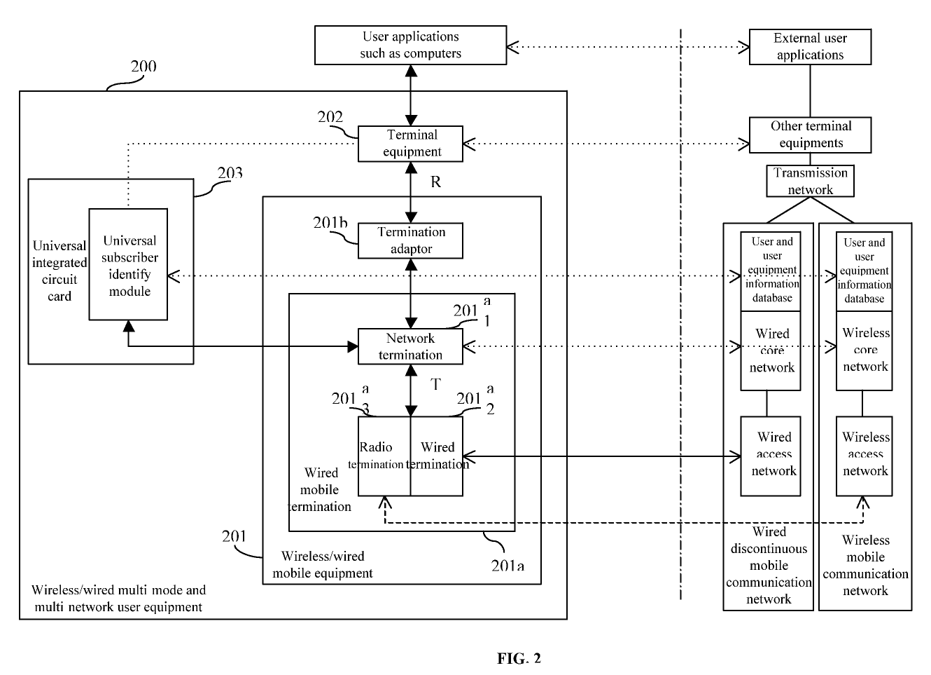

FIG. 2 is another structural implementation of the user equipment and wired discontinuous mobile communication function of the invention, namely it is a principle structural diagram for a wireless/wired multi-mode and multi-network user equipment converging a wireless mobile communication function and a wired discontinuous mobile communication function. The wireless/wired multi-mode and multi-network user equipment 200 of the invention comprises a wireless/wired mobile equipment 201, a terminal equipment 202, and a universal integrated circuit card 203. The wired mobile equipment 201 comprises a wireless/wired mobile termination 201a and a termination adaptor 201b, and the wireless/wired mobile termination 201a comprises a network termination 201a1, a wired termination 201a2, and a radio termination 201a3. The universal integrated circuit card 203 comprises a universal subscriber identify module. The universal subscriber identify module may be a wireless/wired multi-network universal subscriber identify module, a wired single-network universal subscriber identify module, or a wireless single/multi network universal subscriber identify module. The wireless/wired multi-mode and multi-network user equipment 200 may operate as the wired discontinuous mobile user equipment or the wireless mobile user equipment if the universal subscriber identify module is the wireless/wired multi-network universal subscriber identify module, as the wired single-mode user equipment if the universal subscriber identify module is the wired single-network universal subscriber identify module, and as the wireless mobile communication user equipment if the universal subscriber identify module is the wireless single/multi network universal subscriber identify module. The network termination 201a1 in the wireless/wired mobile termination 201a is connected to the wired termination 201a2 and the radio termination 201a3, through a T reference point interface, and the wireless/wired mobile termination 201a in the wireless/wired mobile equipment 201 is respectively connected to the termination adaptor 201b and the universal subscriber identify module in the universal integrated circuit card 203 via the network termination 201a1. The wireless/wired mobile equipment 201 is connected to the terminal equipment 202 via the termination adaptor 201b, referring to the R reference point. The wireless/wired multi-mode and multi-network user equipment 200 is connected to external user applications, such as computers, via the terminal equipment 202; to a wired access network in the wired discontinuous mobile communication network via the wired termination 201a2 of the wireless/wired mobile termination 201a in the wireless/wired mobile equipment 201; and to a wireless access network in the wireless mobile communication network via the radio termination 201a3.

Logically, the wireless/wired multi-mode and multi-network user equipment 200 is divided into two independent logic function components: the wired discontinuous mobile communication user equipment logic function component and a wireless mobile communication user equipment logic function component. A wired mobile termination functional component comprising the wired termination 201a2 and the network termination 201a1, a wired mobile equipment functional component comprising the termination adaptor 201b and a wired mobile termination, the terminal equipment 202, and the universal subscriber identify module in the universal integrated circuit card 203 altogether form a complete logic function component for the wired user equipment, the specific functions of which are the same as those illustrated and described in FIG. 1. A wireless mobile termination function component, comprising the radio termination 201a3 and the network termination 201a1, a wired mobile equipment functional component comprising the termination adaptor 201b and a wired mobile termination, the terminal equipment 202, and the universal subscriber identify module in the universal integrated circuit card 203 altogether form a complete logic function component for the wireless user equipment, the functions of which comprise one or more wireless mobile communication technologies such as 2G GSM/GPRS, IS95A/B, IMT-2000 WCDMA, CDMA2000, TD-SCDMA, and so on. Except for the fact that the wired termination 201a2 and the radio termination 201a3 in the wireless/wired mobile equipment 201 are two comparatively independent components due to big difference in physical hardware implementation between wired access and wireless access, the network termination 201a1 converges functions of both the wireless mobile core network and the wired discontinuous mobile core network. The universal subscriber identify module in the universal integrated circuit card 203 also converges the functions of the user and user equipment information databases in the wireless mobile core network and the wired discontinuous mobile core network. The terminal equipment 202 provides a functional device with uniform and same user terminal applications for the wireless mobile network and the wired discontinuous mobile communication network on a communication service platform of the wireless/wired mobile equipment 201, converging multiple modes and networks.

As shown in FIG. 2, since the user equipment 200 of the invention is a multi-mode and multi-network user equipment, the components and functions thereof in the user equipment 200 respectively correspond to those in the wired discontinuous mobile communication network and the wireless mobile communication network, the network termination 201a1 corresponding to a switching component, a routing component and a control component in a wireless mobile core network and a wired discontinuous mobile core network, the wired termination 201a2 corresponding to a wired access network, the radio termination 201a3 corresponding to a wireless access network, the terminal equipment 202 corresponding to a terminal equipment in an external communication network, and the universal subscriber identify module in the universal integrated circuit card 203 corresponding to user and user equipment information databases in different core networks based on the single/multi network attributes thereof.

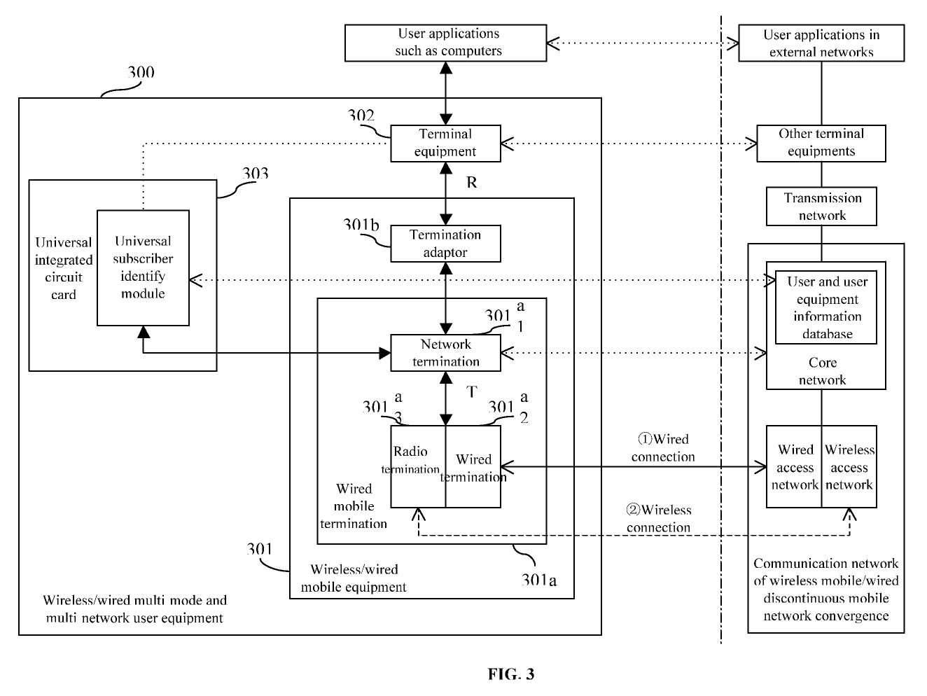

FIG. 3 is a further implementation of the user equipment of this invention, namely an embodiment of a wireless/wired multi-mode and multi-network user equipment in a communication network of wireless mobile/wired discontinuous mobile network convergence.

Before power is enabled, the universal integrated circuit card 303 or the universal subscriber identify module therein is plugged into the wireless/wired multi-mode and multi-network user equipment 300. After the power is enabled, the universal subscriber identify module transmits subscriber network attributes, along with subscriber and service information data to the wireless/wired mobile termination 301a for detection and attachment. If a subscriber network attribute is a wired single-network attribute, the user equipment 300 disables the logic function component of the wireless mobile communication user equipment, and operates as a wired discontinuous mobile communication user equipment at this point. If the subscriber network attribute is a wireless single/multi network attribute, the user equipment 300 disables the logic function component of the wired discontinuous mobile communication user equipment, and only operates as a wireless mobile communication user equipment at this point. If the subscriber network attribute is a wired/wireless multi-network attribute, the user equipment 300 operates as a wireless/wired multi-mode and multi-network user equipment. If the subscriber network attribute is a wireless/wired multi-network attribute and the user equipment automatically selects between wired access and wireless access, priority is given to wired access, namely, the wireless/wired mobile termination 301a in the user equipment 300 first detects whether the wireless/wired mobile termination 301a is wire-connected to a wired access network. If the wireless/wired mobile termination 301a is wire-connected to the wired access network, the user equipment 300 preferentially enables the logic function component of the wired discontinuous mobile communication user equipment, attempts to access the wired access network, disables the logic function component of the wireless mobile communication user equipment if the access is successful, and operates as a wired discontinuous mobile communication user equipment for wired access communication. If the wired access is unsuccessful or the user equipment 300 is not wire-connected to the wired access network, the user equipment 300 disables the logic function component of the wired discontinuous mobile communication user equipment, and enables the wireless mobile communication user equipment for wireless access communication. If the user equipment 300 is set to manually select between wired access and wireless access, the access type is determined according to the desire of the subscriber and the actual connection of the user equipment 300.

The user equipment 300 shown in FIG. 3 has a wireless/wired multi-network subscriber attribute. At this point, the user equipment 300 has already exited an offline state and entered a wired access network by a wired connection, acquiring wired access to resources via an uplink/downlink control channels of the wired access network. This allows it to interact with the wired discontinuous mobile communication network, and to implement security management, such as access initialization of the user equipment 300; the establishment of a wired resource control connection; authentication and authorization; wired discontinuous mobility management, such as access position registration and roaming; as well as communication management, such as the authentication of subscriber service information. At this point, the user equipment 300 is in an idle state. If the subscriber requires further communication services, the user equipment 300 needs to cooperate with the wired communication network, to implement the queuing up and establishment of these communication services, along with the allocation and establishment of wired access resource bearer services, to establish an active communication service connection between user layers, and to manage and maintain normal operation of the communication service connection. At this point, the user equipment 300 is in an active state. After a communication service is terminated, any connection between the user layers is terminated, the communication services queue is cleared, the wired access resource bearer services are released, and finally the wired resource control connection, namely the control connection between the user and the core network, is released. At this point, the user equipment 300 returns to the idle state. If the user equipment 300 terminates the wired connection to the wired access network, and is not reconnected thereto in a preset time, the wireless/wired multi-network universal subscriber identify module in the universal integrated circuit card 303 detaches the subscriber network attributes and subscriber and service information for wired communication from the wireless/wired mobile termination 301a, storing any necessary data in the universal subscriber identify module in the universal integrated circuit card 303, and transmitting the subscriber network attributes and the subscriber and service information related to the wireless communication network to the wireless/wired mobile termination 301a for detection and attachment. The user equipment 300 then disables the logic function component of the wired mobile communication user equipment, enables the logic function component of the wireless mobile communication user equipment, and accesses the wireless access network and the core network to communicate as a wireless mobile communication user equipment.

During the processes discussed above for wired discontinuous mobile access and communication, various functional elements in the logic function component of the wired discontinuous mobile communication user equipment in the user equipment 300 of the invention are required to correspond to the functional elements and functions thereof in the wired discontinuous mobile communication network.

The above embodiments of the invention do not limit the applications of the wireless/wired multi-mode user equipment in a communication network of wireless/wired network convergence. It is also possible to embody the advantages of the invention via applications of the wired user equipment of the invention in a wired discontinuous mobile communication network, applications of the wireless/wired multi-mode user equipment in a multi-network environment with an independent wireless mobile communication network and a wired discontinuous mobile communication network, and implementation of other services.

The appended claims embody the principles, structure, and functions of the invention, along with the preferred embodiments having been described above in detail, which make it possible for those skilled in the art to produce, utilize, or use the invention. Modifications and the diverse variations to these preferred embodiments are apparent to those skilled in the art, and the general principles defined herein may be applicable to other embodiments without employing inventive creativity. Therefore, the invention is not limited to the embodiments illustrated herein, but is contemplated according to the broadest scope formed by the principles and new characteristics disclosed herein.

What is claimed is:

1. A user equipment having a wired discontinuous mobile communication function, comprising: a wired mobile equipment comprising a wired mobile termination and a termination adaptor, the wired mobile termination comprising a wired termination and a network termination; a universal integrated circuit card comprising a universal subscriber identify module; and a terminal equipment.

2. The user equipment in accordance with claim 1, wherein
the wired termination and the network termination in the wired mobile termination are connected according to an architecture defined by ITU-T1.410 through a T reference point interface;
the wired mobile termination in the wired mobile equipment is respectively connected to the termination adaptor and the universal subscriber identify module of the universal integrated circuit card via the network termination thereof;
the wired mobile equipment is connected to the terminal equipment via the termination adaptor referring to an R reference point;
the wired user equipment is connected to external user applications such as computers and so on via the terminal equipment; and
the wired termination of the wired mobile termination in the wired mobile equipment is connected to a wired access network of a wired discontinuous mobile communication network.

3. The user equipment in accordance with claim 1, wherein
the user equipment is a network functional element of the wired discontinuous mobile communication network and a network access device used by a subscriber;
the user equipment provides communication service application interfaces and services to the subscriber; the user equipment has a unique and fixed international mobile equipment identity, a service provision function, a network login and logoff function, an access address and a location updating function; the user equipment provides a standard interface for plugging in the universal integrated circuit card and the universal subscriber identify module; the user equipment has a function of basic subscriber identification and variable utilization for different subscribers; the user equipment provides a user interface; the user equipment supports emergency calls without subscriber identification; the user equipment has the capabilities of an application programming interface, as well as downloading and storing information, services, functions and protocols; and the user equipment has a function for maintaining a virtual home environment as roaming occurs; the wired mobile equipment is responsible for terminating the functions of all control planes and wired discontinuous mobile communication network bearer services of a user layer, the termination adaptor thereof is responsible for adaptation between the wired mobile equipment and the terminal equipment referring to the R reference point, the wired mobile equipment thereof is an originating and terminating end of wired transmission over the wired discontinuous mobile communication network that meets with different requirements for wired transmission, the wired mobile equipment is able to change the access address and position thereof in a wired access network and transfer and switch to the coverage area of another wired access network via the same wired access technology, and the wired mobile equipment is a service terminal of the wired communication network system that is responsible for terminating communication network system service; the network termination thereof is responsible for wired discontinuous mobility management and communication management, such as circuit service call control and packet service session management according to a non-access layer protocol, and for terminating a wired discontinuous mobile core network service, and the wired termination cooperates with the wired access network for wired-access to the discontinuous mobile wired communication network via an access layer protocol, is responsible for terminating all services employing the wired access technology, and is a termination of the access layer; and
the user equipment in accordance with claim 1, wherein the terminal equipment is a functional device providing subscriber terminal applications, which interoperates with the wired mobile termination via the R reference point and the termination adaptor, allowing the subscriber to receive normalized communication services and to terminate communication services transmitted via the wired discontinuous mobile communication network bearer service, and provides the subscriber with applications, such as computer devices with application interface service support; and
the universal subscriber identify module in the universal integrated circuit card terminates independent control functions of the user in the local network, and stores subscriber network attributes, along with subscriber and service information data required for security management, access control, wired discontinuous mobility management, call control and communication management, as the user equipment accesses the wired discontinuous mobile communication network, the service information data mainly comprising:
management data such as fixed data including fixed and unique telephone numbers, identification numbers, key data for security algorithms, subscriber network attributes, network access permission information and so on; temporary network data such as address information for the current position, wired discontinuous mobility management information, encrypted data, and so on;
service-related information comprising internal data relating to the availability and permission status of various services; some small applications such as JAVA;
and personal subscriber data.

4. The user equipment in accordance with claim 1, wherein another architecture of the user equipment is a wireless/wired multi-mode and multi-network user equipment converging a wireless mobile communication function and a wired discontinuous mobile communication function, and comprising a wireless/wired mobile equipment, a terminal equipment, and a universal integrated circuit card; the wireless/wired mobile equipment comprises a wireless/wired mobile termination and a termination adaptor, the wireless/wired mobile termination comprises a network termination, a wired termination, and a radio termination; and
the universal integrated circuit card comprises a universal subscriber identify module, which is a wireless/wired multi-network universal subscriber identify module, a wired single-network universal subscriber identify module, or a wireless single/multi network universal subscriber identify module; the user equipment operates as the wired discontinuous mobile user equipment or the wireless mobile user equipment if the universal integrated circuit card is a wireless/wired multi-network universal subscriber identify module, only as a wired single-mode user equipment if the universal integrated circuit card is a wired single-network universal subscriber identify module, and only as a wireless mobile communication user equipment if the universal integrated circuit card is a wireless single/multi network universal subscriber identify module.

5. The user equipment in accordance with claim 4, wherein
the multi-mode and multi-network user equipment is logically divided into two independent functional entities: a wired discontinuous mobile communication user equipment and a wireless mobile communication user equipment, which is enabled or disabled according to the subscriber single/multi network attribute of the universal subscriber identify module in the universal integrated circuit card, along with the actual access type of the user equipment;
a wired mobile termination function component comprising the wired termination and the network termination, a wired mobile equipment function component comprising the termination adaptor and a wired mobile termination, the terminal equipment and the universal subscriber identify module in the universal integrated circuit card, which altogether form a complete logic function component of the wired user equipment; and
a wireless mobile terminal function component comprising the radio termination and the network termination, a wireless mobile equipment comprising the termination adaptor and a wired mobile termination, the terminal equipment and the universal subscriber identify module in the universal integrated circuit card, which altogether form a complete logic function component of the wireless user equipment, the functions of which comprise one or more wireless mobile communication technologies such as 2G GSM/GPRS, IS95A/B, IMT-2000 WCDMA, CDMA2000, TD-SCDMA, and so on.

6. The user equipment in accordance with claim 4, wherein
the network termination is connected to the wired termination and the radio termination through a T reference point interface;
the wireless/wired mobile termination in the wireless/wired mobile equipment is respectively connected to the termination adaptor and the universal subscriber identify module in the universal integrated circuit card via the network termination thereof;
the wireless/wired mobile equipment is connected to the terminal equipment via the termination adaptor referring to the R reference point; and
the wireless/wired multi-mode and multi-network user equipment is connected to external user applications, and to the wired access network in the wired discontinuous mobile communication network via the wired termination of the wireless/wired mobile termination in the wireless/wired mobile equipment, with the radio termination connected to the wireless access network in the wireless mobile communication network.

7. The user equipment in accordance with claim 4, wherein
the wired termination and the radio termination are two comparatively independent components due to the big difference in physical hardware implementation between wired access and wireless access, and the network termination converging the functions of both a wireless mobile core network and a wired discontinuous mobile core network;
the universal subscriber identify module in the universal integrated circuit card converging the functions of the user and user equipment information databases in the wireless mobile core network and the wired discontinuous mobile core network; and
the terminal equipment provides a functional device with uniform and same user terminal applications for the wireless mobile network and the wired discontinuous mobile communication network on a multi-mode and multi-network wireless/wired mobile equipment creating a communication service platform.

8. A method applicable to a user equipment with a wired discontinuous mobile communication function, wherein the user equipment changes its access address and position in a wired discontinuous mobile communication network, and switches to the coverage area of a wired access network in another wired discontinuous mobile communication network for various communication services and applications via the same wired access technology, without changing the fixed and unique number thereof.

9. The method in accordance with claim 8, wherein
there are two implementations of the user equipment, the first is a single-mode wired user equipment with only a wired discontinuous mobile communication function, and the other is a wireless/wired multi-mode and multi-network user equipment converging a wireless mobile communication function and a wired discontinuous mobile communication function, the wireless mobile communication function comprising one or more wireless mobile communication technologies, such as 2G GSM/GPRS, IS95A/B, IMT-2000 WCDMA, CDMA2000, TD-SCDMA, and so on, with the wireless/wired multi-mode and multi-network user equipment logically divided into two independent functional entities: a wired discontinuous mobile communication user equipment and a wireless mobile communication user equipment, which is enabled or disabled according to a subscriber single/multi network attribute of a universal subscriber identify module in a universal integrated circuit card, along with the actual access type of the user equipment.

10. The method in accordance with claim 8, comprising:
a) plugging the universal integrated circuit card or the universal subscriber identify module thereof into the wireless/wired multi-mode and multi-network user equipment before power is enabled;
b) transmitting subscriber network attributes, along with subscriber and service information data to the wireless/wired multi-mode and multi-network user equipment for detection and attachment by the universal subscriber identify module after power is enabled;
c) disabling a logic function component of the wireless mobile communication user equipment by the user equipment, and operating as a wired discontinuous mobile communication user equipment by the user equipment at this point if the subscriber network attribute is a wired single-network attribute; disabling a logic function component of the wired discontinuous mobile communication user equipment by the user equipment, and only operating as a wireless mobile communication user equipment by the user equipment at this point if the subscriber network attribute is a wireless single/multi network attribute; operating as a wireless/wired multi-mode and multi-network user equipment by the user equipment if the subscriber network attribute is a wired/wireless multi-network attribute;
d) giving priority to wired access if the subscriber network attribute is a wireless/wired multi-network attribute and the user equipment automatically selects between wired access and wireless access, namely, first detecting whether the wireless/wired mobile termination in the user equipment is wire-connected to a wired access network by the wireless/wired mobile termination, enabling the logic function component of the wired discontinuous mobile communication user equipment, attempting to access the wired access network, disabling the logic function component of the wireless discontinuous mobile communication user equipment if the access is successful, and operating as a wired discontinuous mobile communication user equipment for wired access communication by the user equipment if the wired connection is successful, as well as disabling the logic function component of the wired discontinuous mobile communication user equipment and enabling the wireless mobile communication user equipment for wireless access communication by the user equipment if the wired access is unsuccessful or the wireless/wired mobile termination in the user equipment is not wire-connected to the wired access network;
e) determining an access type according to the desire of the subscriber and the actual connection of the user equipment if the user equipment is set to manually select between wired access and wireless access;
f) wired accessing resources via an uplink/downlink control channels of wired access network by the user equipment, as the user equipment having a wireless/wired multi-network attribute is connected to the wired access network, in order to interact with the wired discontinuous mobile communication network, and to implement security management, such as access initialization of the user equipment, the establishment of a wired resource control connection, authentication and authorization, wired discontinuous mobility management such as access position registration and roaming, along with communication management, such as the authentication of subscriber service information; the user equipment is in an idle state at this point;
g) cooperating with the wired communication network by the user equipment, to implement queuing and the establishment of communication services, along with the allocation and establishment of wired access resource bearer services, to establish an active communication service connection between user layers, and to manage and maintain normal operation of the communication service connection; the user equipment is in an active state at this point;
h) terminating the connection between the user layers before clearing the communication services queue, releasing the wired access resource bearer services, and finally releasing the wired resource control connection, namely the control connection between the user and the core network; the user equipment returns to an idle state at this point; and
i) detaching the subscriber network attributes and the subscriber and service information of the wired communication from the wireless/wired mobile termination, storing necessary data in the universal subscriber identify module in the universal integrated circuit card, and transmitting the subscriber network attributes and the subscriber and service information related to the wireless communication network to the wireless/wired mobile termination for detection and attachment by the wireless/wired multi-network universal subscriber identify module, disabling the logic function component of the wired mobile communication user equipment, enabling the logic function component of the wireless mobile communication user equipment, and accessing the wireless access network and the core network to communicate as a wireless mobile communication user equipment by the user equipment, if the user equipment disconnects the wired connection to the wired access network in the idle state, and is not reconnected thereto in a preset time.
